(19) United States
(12) Patent Application Publication
(10) Pub. No.: US 2015/0304701 A1
(43) Pub. Date: Oct. 22, 2015

(54) PLAY CONTROL METHOD AND DEVICE

(71) Applicants: Hisense Co., Ltd, Qingdao (CN); HISENSE USA CORPORATION, Suwanee, GA (US)

(72) Inventors: Zhiqiang LI, Qingdao (CN); Xin ZHANG, Qingdao (CN)

(21) Appl. No.: 14/338,243

(22) Filed: Jul. 22, 2014

(30) Foreign Application Priority Data
Apr. 17, 2014 (CN) 201410155879.7

(51) Int. Cl. H04N 21/422

(52) U.S. Cl. CPC H04N 21/4222; H04N 21/42207; H04N 21/42208

(57) ABSTRACT

A play control method including: a TV set device receiving a media play request message sent by a mobile device, wherein the media play request message carries indication information of a media program requested to be played, and the indication information of the media program indicates at least a source of the media program, and the indication information of the media program is stored by the mobile device according to the media program played by the TV set device or another TV set device or received from the TV set device or the another TV set device or another mobile device; and the TV set device playing the media program corresponding to the indication information of the media program in response to the media play request message.

### CROSS-REFERENCES TO RELATED APPLICATIONS

This application claims priority to Chinese patent application No. 201410155879.7 filed on Apr. 17, 2014, the content of which is incorporated herein by reference in its entirety.

### FIELD

The present disclosure relates to the field of wireless communications and particularly to a play control method and device.

### BACKGROUND

Along with the popularization of TV set devices (e.g., smart TV sets), the content that can be presented by a TV set device has also become increasingly abundant, and a user performs play control on the TV set device using various functional press keys (such as physical buttons) of a traditional remote controller, for example, controls the volume of the TV set device to be increased or decreased by adjusting a volume press key, or turns on or off a display device of the TV set device by adjusting a power press key.

### SUMMARY

According to one or more aspects of the present disclosure, a play control method includes:

receiving, by a TV set device, a media play request message sent by a mobile device, wherein the media play request message carries indication information of a media program requested to be played, and the indication information of the media program indicates at least a source of the media program, and the indication information of the media program is stored by the mobile device according to the media program played by the TV set device or another TV set device or received from the TV set device or the another TV set device or another mobile device; and

playing, by the TV set device, the media program corresponding to the indication information of the media program in response to the media play request message.

According to another aspect of the present disclosure, a play control method includes:

receiving, by a mobile device, a notification message sent by a TV set device and storing indication information of a media program according to the notification message, wherein the notification message carries a source of the media program played by the TV set device, and the indication information of the media program includes the source of the media program played by the TV set device; or receiving, by the mobile device, indication information of a media program from the TV set device or another mobile device, wherein the indication information indicates at least the source of the media program; and

carrying, by the mobile device, the indication information of the media program in a media play request message and sending the media play request message to the TV set device or another TV set device to instruct the TV set device or the another TV set device to play the media program corresponding to the indication information of the media program in response to the media play request message.

According to another aspect of the present disclosure, a TV set device includes:

a memory; and

one or more processors,

wherein computer readable program codes are stored in the memory and executed by the one or more processors to implement:

receiving a media play request message sent by a mobile device, wherein the media play request message carries indication information of a media program requested to be played, and the indication information of the media program indicates at least a source of the media program, and the indication information of the media program is stored by the mobile device according to the media program played by the TV set device or another TV set device or received from the TV set device or the another TV set device or another mobile device; and

playing the media program corresponding to the indication information of the media program in response to the media play request message.

According to still another aspect of the present disclosure, a mobile device includes:

a memory; and

one or more processors,

wherein computer readable program codes are stored in the memory and executed by the one or more processors to implement:

receiving a notification message sent by a TV set device and storing indication information of a media program according to the notification message, wherein the notification message carries a source of the media program played by the TV set device, and the indication information of the media program includes the source of the media program played by the TV set device; or receiving indication information of a media program from the TV set device or another mobile device, wherein the indication information indicates at least the source of the media program; and

carrying the indication information of the media program in a media play request message and sending the media play request message to the TV set device or another TV set device to instruct the TV set device or the another TV set device to play the media program corresponding to the indication information of the media program in response to the media play request message.

### BRIEF DESCRIPTION OF THE DRAWINGS

In order to make the technical solutions in some of the embodiments more apparent, the drawings to be used in a description of the embodiments will be briefly introduced below, and apparently the drawings to be described below are merely illustrative of some of the embodiments of the disclosure, and those ordinarily skilled in the art may derive other drawings from these drawings. In the drawings:

FIG. 1 is a schematic diagram of a system architecture according to some embodiments;

FIG. 2 is a schematic diagram of another system architecture according to some embodiments;

FIG. 3 is a schematic flow chart of a play control method according to some embodiments;

FIG. 4 is a schematic flow chart of another play control method according to some embodiments;

FIG. 5 is a schematic flow chart of still another play control method according to some embodiments;

FIG. 6 is a schematic flow chart of still another play control method according to some embodiments;

FIG. 7 is a schematic structural diagram of a TV set device according to some embodiments;

FIG. 8 is a schematic structural diagram of a mobile device according to some embodiments;

FIG. 9 is a schematic structural diagram of a TV set device according to some embodiments; and

FIG. 10 is a schematic structural diagram of a mobile device according to some embodiments.

### DETAILED DESCRIPTION OF CERTAIN EMBODIMENTS

In order to make the objects, the technical solutions and advantages of one or more aspects of the disclosure more apparent, the disclosure will be further described with reference to the drawings. Apparently, the described embodiments are only a part but not all of the embodiments of the disclosure. Based on the embodiments of the disclosure, all other embodiments derived by those ordinarily skilled in the art therefrom shall also come into the scope of the disclosure.

In one or more aspects, some embodiments provide a play control method and device, so as to control a TV set device by using a mobile device to reach a media program.

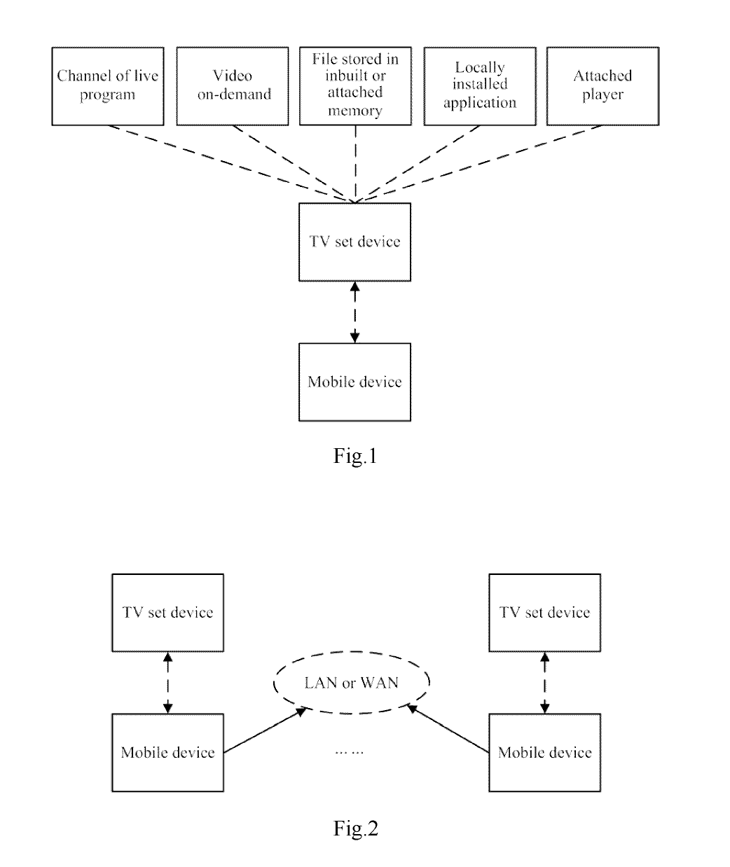

Some embodiments may be applicable to the scenario where a TV set device is controlled by a mobile device to play media, for example, a plurality of TV set devices are controlled by a mobile device, and some embodiments may be applicable to the scenario where a mobile device instructs a TV set device to play media by obtaining information about a media program shared by another mobile device; and the mobile device in some embodiments may be a smart phone, an iPad or another intelligent terminal, and the TV set device in some embodiments may be an smart TV set. FIG. 1 illustrates a schematic diagram of an architecture where a TV set device is controlled by a mobile device to play media according to some embodiments, and FIG. 2 illustrates a schematic diagram of an architecture in the scenario where a mobile device instructs a TV set device to play media by obtaining information about a media program shared by another mobile device according to some embodiments, where two mobile devices and two TV set devices are illustrated in FIG. 2, but a plurality of mobile devices and a plurality of TV set devices can be involved in a practical application.

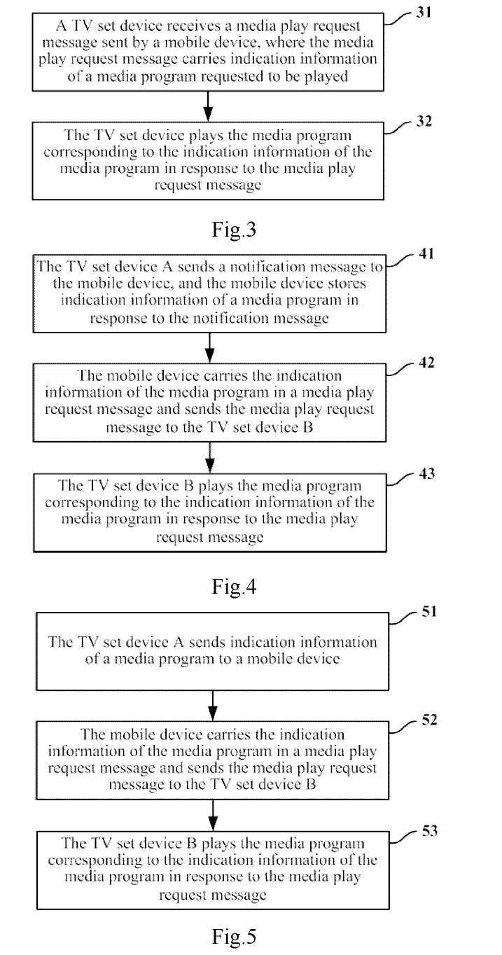

FIG. 3 illustrates a schematic flow chart of a play control method according to some embodiments, and in the scenario where a mobile device is connected with a TV set device and instructs the TV set device to run various media files or applications, referring to FIG. 3, the method includes the following steps.

Step 31: A TV set device receives a media play request message sent by a mobile device, where the media play request message carries indication information of a media program requested to be played, and the indication information of the media program indicates at least a source of the media program, and the indication information of the media program is stored by the mobile device according to the media program played by the TV set device.

In some embodiments, the source of the media program includes one or a combination of: a channel of a live program, video on-demand, a file stored in an inbuilt or attached memory, a locally installed application and an attached player.

Optionally, before the step 31, the mobile device may store the indication information of the media program according to the media program played by the TV set device as follows: the TV set device sends a notification message to the mobile device, where the notification message carries the source of the media program played by the TV set device, and the mobile device stores the indication information of the media program according to the notification message, where the indication information of the media program includes the source of the media program played by the TV set device.

Optionally, the notification message further carries an identifier of the media program played by the TV set device, and the identifier includes one or a combination of: a channel number of the live program, a program identifier of the video on-demand program, an identifier of the file stored in the inbuilt or attached memory, an identifier of the application and an identifier of the attached player. The indication information of the media program stored by the mobile device further includes the identifier of the media program played by the TV set device.

Optionally, the TV set device sends the notification message to the mobile device as follows: the TV set device sends the notification message to the mobile device at a preset time interval; or the TV set device sends the notification message to the mobile device upon detection of a change to a focus of a window or a change to the source of the media program played in the window where the focus is located; or the mobile device may send a request message on its own initiative to the TV set device to obtain the notification message about the media program played by the TV set device, where the request message triggers the TV set device to send the notification message to the mobile device upon reception of the request message.

Step 32: The TV set device plays the media program corresponding to the indication information of the media program in response to the media play request message.

Optionally, when the source of the media program played by the TV set device is video on-demand, the notification message further carries play progress information, and the indication information of the media program stored by the mobile device further includes the play progress information of the media program played by the TV set device; and in the step 32, the TV set device plays the media program corresponding to the indication information of the media program in response to the media play request message as follows: the TV set device parses the indication information of the media program in the media play request message for the identifier and the play progress information of the media program and plays the media program corresponding to the identifier of the media program according to the play progress information.

In an embodiment, the TV set device plays the media program (e.g., a live program, a video on-demand program, a media program stored in the inbuilt or attached memory, the locally installed application and a media program played by the attached player) after being connected with the mobile device over a network access device, and when the TV set device periodically obtains information about the played media program (e.g., picture quality information, voice quality information, channel information, the program contents, a source, an identifier, user comment information, etc.), or when the TV set device detects a change to special information of the played media program (e.g., the channel information, the program contents, the source, the identifier, etc.), the TV set device sends the notification message carrying at least the source of the media program played by the TV set device to the mobile device, where the notification message may further carry the channel information, the program contents, the identifier, etc., and particularly when the media program played by the TV set device is a video on-demand program, the notification message may further carry play progress information of the video on-demand program.

The mobile device can present the notification message to a user upon reception of the notification message sent by the TV set device for the user to browse the information about the media program played by the TV set device (e.g., the picture quality information, the voice quality information, the channel information, the program contents, the source, the identifier, the user comment information, etc.), and the user can choose as desired whether to save the information about the media program played by the TV set device, and if the user chooses to save it, then the mobile device stores at least the source, of the media program played by the TV set device, carried in the notification message as the indication information of the media program; or if the user chooses not to save it, then the mobile device will not generate any indication information of the media program.

In some embodiments:

When the source of the media program is a channel of a live program, the indication information of the media program may include a first source and a first identifier, where the first source indicates the source of the media program, and the first identifier indicates a channel number of the live program.

When the source of the media program is video on-demand, the indication information of the media program may include a second source and a second identifier, where the second source indicates the source of the media program, and the second identifier indicates the program identifier of the video on-demand program.

When the source of the media program is a file stored in an inbuilt or attached memory, the indication information of the media program may include a third source and a third identifier, where the third source indicates the source of the media program, and the third identifier indicates the identifier of the file stored in the inbuilt or attached memory.

When the source of the media program is a locally installed application, the indication information of the media program may include a fourth source and a fourth identifier, where the fourth source indicates the source of the media program, and the fourth identifier indicates the identifier of the application.

When the source of the media program is an attached player, the indication information of the media program may include a fifth source and/or a fifth identifier, where the fifth source indicates the source of the media program, and the fifth identifier indicates the identifier of the attached player.

After the mobile device carries the indication information of the media program in the media play request message and sends the media play request message to the TV set device, the TV set device plays the media program corresponding to the indication information of the media program in response to the received media play request message.

When the indication information carried in the media play request message includes the first source and the first identifier, the TV set device enters a play interface of the live program and plays the live program at the channel number indicated by the first identifier.

By way of an example, the indication information carried in the media play request message includes a live program of CCTV-6, and then the TV set device plays a program live on CCTV-6 in response to the media play request message.

When the indication information carried in the media play request message includes the second source, the second identifier and the play progress information, the TV set device enters a play interface of video on-demand and plays the video on-demand program according to the program identifier of the video on-demand program indicated by the second identifier and the play progress information.

By way of an example, the indication information carried in the media play request message includes a video on-demand program Explore•Discovery-1, and then the TV set device plays the first episode of the Explore•Discovery in response to the media play request message.

When the indication information carried in the media play request message includes the third source and the third identifier, the TV set device enters a play interface of the file stored in the inbuilt or attached memory and plays the program according to the identifier, of the file stored in the inbuilt or attached memory, indicated by the third identifier.

By way of an example, the indication information carried in the media play request message includes a Movie Name.MP4 in an attached U-disk, and then the TV set device plays the Movie Name.MP4 in response to the media play request message.

When the indication information carried in the media play request message includes the fourth source and the fourth identifier, the TV set device enters a menu interface of the application and runs the application according to the identifier of the application indicated by the fourth identifier.

By way of an example, the indication information carried in the media play request message includes an application Angry Bird.APK, and then the TV set device runs the application Angry Bird.APK.

When the indication information carried in the media play request message includes the fifth source and the fifth identifier, the TV set device enters a play interface of the attached player and plays the program according to the identifier of the attached player indicated by the fifth identifier.

By way of an example, the indication information carried in the media play request message includes HDMI1, and then the TV set device plays an audio or video signal input by the attached player identified as HDMI1.

It shall be noted that when the indication information carried in the media play request message includes only the fifth identifier, the TV set device can play directly the audio or video signal input by the attached player by recognizing the identifier of the attached player. In some embodiments, the attached player may include but will not be limited to a High Definition Multimedia Interface (HDMI) device, a Video Graphics Array (VGA) device, etc.

FIG. 4 illustrates a schematic flow chart of another play control method according to some embodiments, and in the scenario where a mobile device is connected respectively with two TV set devices (for the sake of a better description of some embodiments, hereinafter one of the TV set devices will be referred to as a TV set device A, and the other TV set device will be referred to as a TV set device B) through a network access device and sends a media play request message to the TV set device B upon reception of a notification message send by the TV set device A to instruct the TV set device B to play a media program played by the TV set device A, referring to FIG. 4, the method includes the following steps.

Step 41: The TV set device A sends a notification message to the mobile device, where the notification message carries a source of a media program played by the TV set device A, and the mobile device stores indication information of the media program according to the notification message, and the indication information of the media program includes the source of the media program played by the TV set device A.

Optionally, in the step S41, the TV set device A sends the notification message to the mobile device as follows: the TV set device A sends the notification message to the mobile device at a preset time interval; or the TV set device A sends the notification message to the mobile device upon detection of a change to a focus of a window or a change to the source of the media program played in the window where the focus is located; or the mobile device may send a request message on its own initiative to the TV set device A to obtain the notification message about the media program played by the TV set device A, where the request message triggers the TV set device A to send the notification message to the mobile device upon reception of the request message.

Optionally, the notification message further carries an identifier of the media program played by the TV set device A, and the indication information of the media program stored by the mobile device further includes the identifier of the media program played by the TV set device A.

In some embodiments:

When the source of the media program is a channel of a live program, the indication information of the media program may include a first source and a first identifier, where the first source indicates the source of the media program, and the first identifier indicates a channel number of the live program.

When the source of the media program is video on-demand, the indication information of the media program may include a second source and a second identifier, where the second source indicates the source of the media program, and the second identifier indicates the program identifier of the video on-demand program.

When the source of the media program is a file stored in an inbuilt or attached memory, the indication information of the media program may include a third source and a third identifier, where the third source indicates the source of the media program, and the third identifier indicates the identifier of the file stored in the inbuilt or attached memory.

When the source of the media program is a locally installed application, the indication information of the media program may include a fourth source and a fourth identifier, where the fourth source indicates the source of the media program, and the fourth identifier indicates the identifier of the application.

When the source of the media program is an attached player, the indication information of the media program may include a fifth source and/or a fifth identifier, where the fifth source indicates the source of the media program, and the fifth identifier indicates the identifier of the attached player.

Step 42: The mobile device carries the indication information of the media program in a media play request message and sends the media play request message to the TV set device B.

Step 43: The TV set device B plays the media program corresponding to the indication information of the media program in response to the media play request message.

An implementation of the step 43 is the same as that of the step 32, and a repeated description thereof will be omitted here.

FIG. 5 illustrates a schematic flow chart of still another play control method according to some embodiments, and in the scenario where a mobile device is connected respectively with two TV set devices (for the sake of a better description of some embodiments, hereinafter one of the TV set devices will be referred to as a TV set device A, and the other TV set device will be referred to as a TV set device B) through a network access device and sends a media play request message to the TV set device B upon reception of indication information of a media program send by the TV set device A to instruct the TV set device B to play the media program played by the TV set device A, referring to FIG. 5, the method includes the following steps.

Step 51: The TV set device A sends indication information of a media program to the mobile device, where the indication information of the media program is stored by the TV set device A according to the media program played by the TV set device A, and the indication information of the media program includes a source of the media program played by the TV set device A.

Optionally, the indication information of the media program further includes an identifier of the media program played by the TV set device A.

Step 52: The mobile device carries the indication information of the media program in a media play request message and sends the media play request message to the TV set device B.

Step 53: The TV set device B plays the media program corresponding to the indication information of the media program in response to the media play request message.

An implementation of the step 53 is the same as that of the step 32, and a repeated description thereof will be omitted here.

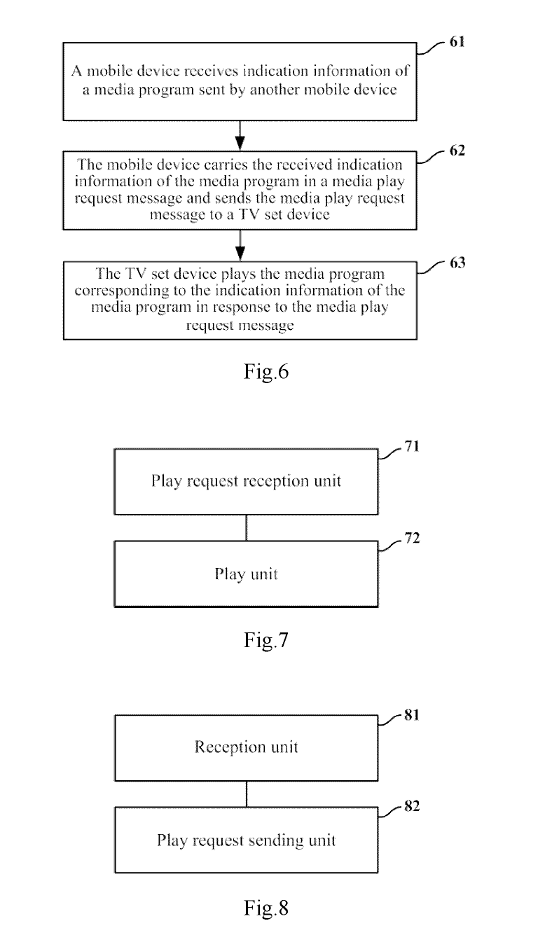

FIG. 6 illustrates a schematic flow chart of another play control method according to some embodiments, where a mobile device instructs a TV set device to play media by obtaining indication information of a media program shared by another mobile device, referring to FIG. 6, the method includes the following steps.

Step 61: A mobile device receives indication information of a media program sent by another mobile device, where the indication information of the media program indicates at least a source of the media program, and the source of the media program includes one or a combination of: a channel of a live program, video on-demand, a file stored in an inbuilt or attached memory, a locally installed application and an attached player.

It shall be noted that the indication information of the media program in the embodiment illustrated in FIG. 6 can be stored in any or more of the schemes mentioned in the above embodiments.

In some embodiments, the mobile device may store the indication information of the media program as in the step 31 and/or the step 41 and create a Uniform Resource Locator (URL) according to the indication information in the format of:

http://localhost:[port]/share?programId=[programID]

In some embodiments, the URL is a local address, and the mobile device can specify a specific port number (e.g., 9090) and set a parameter as a program ID. The URL can be recognized and processed by the mobile device.

The mobile device can have the contents of the URL shared through a mobile social application after creating the URL. The contents can be shared in an existing standard sharing mechanism (e.g., Android sharing). For example, the following contents can be created and shared to a micro-blog: “I am watching the movie XXX on my intelligent TV set, are you interested? The movie is linked at http://localhost:9090/share?programId=1000.”

Other mobile devices can access the URL, pointing to a local address, at the link of the movie above. At this time the mobile device will start in advance a web server to monitor the address and parse the URL for program ID and other information upon reception of a request to access the address.

Step 62: The mobile device carries the received indication information of the media program in a media play request message and sends the media play request message to a TV set device to instruct the TV set device to play the media program corresponding to the indication information of the media program in response to the media play request message.

Step 63: The TV set device plays the media program corresponding to the indication information of the media program in response to the media play request message.

An implementation of the step 63 is the same as that of the step 32, and a repeated description thereof will be omitted here.

As can be apparent from the solution above, on one hand, a method according to some embodiments can enable a mobile device to be integrated deeply with a TV system so as to perform a function of playing rapidly a TV program and also save media programs from a live TV, HDMI, VGA and other numerous input sources as well as to run rapidly applications and games installed on a TV set device. On the other hand, some embodiments make full use of a TV set device and a mobile device in a home network, so that the mobile device can save media programs on one or more TV set devices, to enable the mobile device to instruct a TV set device to run various media files or applications. Furthermore, some embodiments further provide a method of instructing a TV set device by a URL hyperlink shared by a mobile device to run various media files or applications, and apparently there are some embodiments can enable the contents of a program of an intelligent TV to be shared and diffused without deploying any cloud server. Some embodiments can enable a function of instructing a TV set device by a mobile device to run various media files or applications over a home local area network or a wide area network.

Based on the same technical idea, some embodiments provide a TV set device applicable to the above methods, and as illustrated in FIG. 7, the TV set device includes a memory and one or more processors, where computer readable program codes are stored in the memory and executed by the one or more processors to implement:

a play request reception unit 71 configured to receive a media play request message sent by a mobile device, where the media play request message carries indication information of a media program requested to be played, and the indication information of the media program indicates at least a source of the media program, and the indication information of the media program is stored by the mobile device according to the media program played by the TV set device or another TV set device or received from the TV set device or the another TV set device or another mobile device; and

a play unit 72 configured to play the media program corresponding to the indication information of the media program in response to the media play request message.

Optionally, the program codes can be further executed by the processor to implement a notification message sending unit configured to send a notification message to the mobile device, where the notification message carries the source of the media program played by the TV set device, so that the indication information of the media program stored by the mobile device according to the notification message includes the source of the media program played by the TV set device.

Optionally, the notification message further carries an identifier of the media program played by the TV set device, so that the indication information of the media program stored by the mobile device further includes the identifier of the media program played by the TV set device, and the identifier includes one or a combination of: a channel number of a live program, a program identifier of a video on-demand program, an identifier of a file stored in an inbuilt or attached memory, an identifier of an application and an identifier of an attached player.

Optionally, the notification message sending unit is further configured to send the notification message to the mobile device as follows: when the source of the media program played by the TV set device is video on-demand, the notification message further carries play progress information, so that the indication information of the media program stored by the mobile device further includes the play progress information of the media program played by the TV set device; and the play unit 72 is further configured to parse the indication information of the media program in the media play request message for the identifier and the play progress information of the media program and to play the media program corresponding to the identifier of the media program according to the play progress information.

Optionally, the notification message sending unit is further configured to send the notification message to the mobile device at a preset time interval; or to send the notification message to the mobile device upon detection of a change to a focus of a window or a change to the source of the media program played in the window where the focus is located.

Optionally, when the source of the media program is a channel of a live program, the indication information of the media program includes a first source and a first identifier, where the first source indicates the source of the media program, and the first identifier indicates a channel number of the live program; when the source of the media program is video on-demand, the indication information of the media program includes a second source and a second identifier, where the second source indicates the source of the media program, and the second identifier indicates a program identifier of the video on-demand program; when the source of the media program is a file stored in an inbuilt or attached memory, the indication information of the media program includes a third source and a third identifier, where the third source indicates the source of the media program, and the third identifier indicates the identifier of the file stored in the inbuilt or attached memory; when the source of the media program is a locally installed application, the indication information of the media program includes a fourth source and a fourth identifier, where the fourth source indicates the source of the media program, and the fourth identifier indicates the identifier of the application; and when the source of the media program is an attached player, the indication information of the media program includes a fifth source and/or a fifth identifier, where the fifth source indicates the source of the media program, and the fifth identifier indicates the identifier of the attached player.

Based on the same technical idea, some embodiments provide a mobile device applicable to the above methods, and as illustrated in FIG. 8, the mobile device includes a memory and one or more processors, where computer readable program codes are stored in the memory and executed by the one or more processors to implement:

a reception unit 81 configured to receive a notification message sent by a TV set device and to store indication information of a media program according to the notification message, where the notification message carries a source of the media program played by the TV set device, and the indication information of the media program includes the source of the media program played by the TV set device; or to receive the indication information of the media program from the TV set device or another mobile device, where the indication information indicates at least the source of the media program; and

a play request sending unit 82 configured to carry the indication information of the media program in a media play request message and send the media play request message to the TV set device or another TV set device to instruct the TV set device or the another TV set device to play the media program corresponding to the indication information of the media program in response to the media play request message.

Optionally, the reception unit 81 is further configured to receive the notification message sent by the TV set device, where the notification message further carries an identifier of the media program played by the TV set device, and the identifier includes one or a combination of: a channel number of a live program, a program identifier of a video on-demand program, an identifier of a file stored in an inbuilt or attached memory, an identifier of an application and an identifier of an attached player; and the indication information of the media program further includes the identifier of the media program played by the TV set device.

Optionally, the reception unit 81 is further configured to receive the notification message sent by the TV set device as follows: when the source of the media program played by the TV set device is video on-demand, the notification message further carries play progress information, and the indication information of the media program further includes the play progress information of the media program played by the TV set device, so that the TV set device or the another TV set device parses the indication information of the media program in the media play request message for the identifier and the play progress information of the media program and plays the media program corresponding to the identifier of the media program according to the play progress information.

Optionally, when the source of the media program is a channel of a live program, the indication information of the media program includes a first source and a first identifier, where the first source indicates the source of the media program, and the first identifier indicates a channel number of the live program; when the source of the media program is video on-demand, the indication information of the media program includes a second source and a second identifier, where the second source indicates the source of the media program, and the second identifier indicates a program identifier of the video on-demand program; when the source of the media program is a file stored in an inbuilt or attached memory, the indication information of the media program includes a third source and a third identifier, where the third source indicates the source of the media program, and the third identifier indicates the identifier of the file stored in the inbuilt or attached memory; when the source of the media program is a locally installed application, the indication information of the media program includes a fourth source and a fourth identifier, where the fourth source indicates the source of the media program, and the fourth identifier indicates the identifier of the application; and when the source of the media program is an attached player, the indication information of the media program includes a fifth source and/or a fifth identifier, where the fifth source indicates the source of the media program, and the fifth identifier indicates the identifier of the attached player.

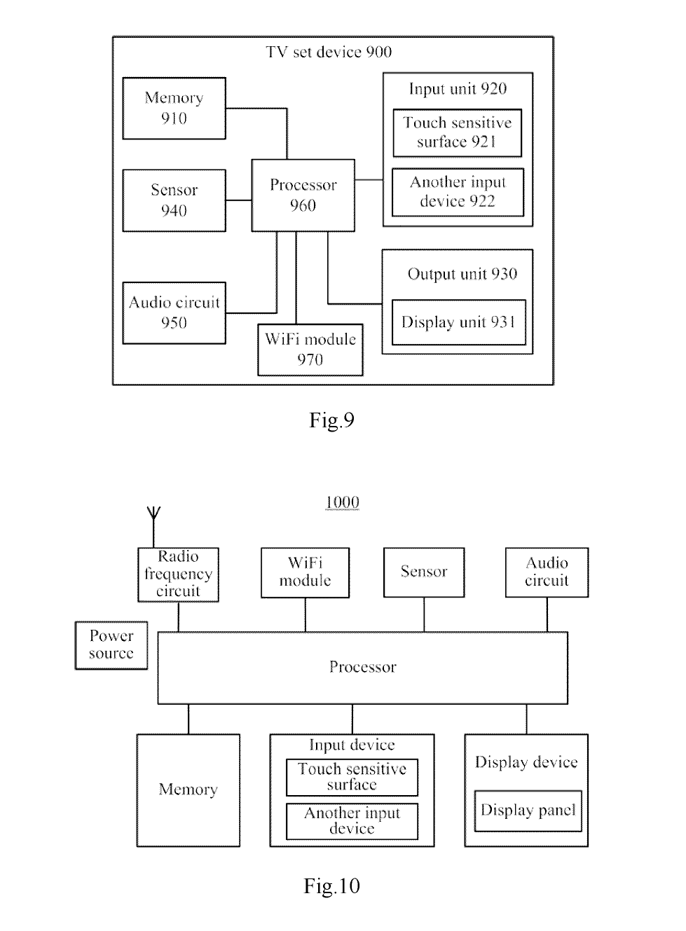

Moreover, some embodiments provide a TV set device, and as illustrated in FIG. 9, the TV set device 900 can include a memory 910 including one or more computer readable storage mediums, an input unit 920, an output unit 930, a sensor 940, an audio circuit 950, a processor 960 including one or more processing cores and other components. Those skilled in the art can appreciate that the structure illustrated in FIG. 9 will not be intended for any limitation on the TV set device, but the TV set device can include more or less components than those illustrated in the figure or have some of the components combined or different component arrangement.

The memory 910 can be configured to store software programs and modules, and the processor 960 is configured to run the software programs and modules stored in the memory 910 to perform various function applications and data processing. The memory 910 can generally include a program storage area and a data storage area, where an operating system, applications required for at least one function (e.g., an audio playing function, an image playing function, etc.), etc., can be stored in the program storage area; and data created for use of the TV set device 900 (e.g., audio data, etc.), etc., can be stored in the data storage area. Moreover, the memory 910 can include a high-speed random access memory and can further include a nonvolatile memory, e.g., at least one magnetic-disk memory device, a flash memory device or another volatile solid memory device. Correspondingly, the memory 910 can further include a memory controller configured to provide an access of the processor 960 and the input unit 920 to the memory 910.

The input unit 920 can be configured to receive input digital or character information and to generate a signal input related to user setting and function control. Particularly, the input unit 920 can include a touch sensitive surface 921 and another input device 922. The touch sensitive surface 921, also referred to as a touch display screen or a touch control pad, can be configured to collect a touch operation by a user thereon or in proximity thereto (e.g., an operation by the user on or in proximity to the touch sensitive surface 921 using his or her finger, a touchpen or any other appropriate object or attachment) and to drive a corresponding connected device according to preset program. Optionally, the touch sensitive surface 921 can include two components which are a touch detection device and a touch controller, where the touch detection device detects the position of touching by the user and detects a signal as a result of the touch operation and transfers the signal to the touch controller; and the touch controller receives the touch signal from the touch detection device and converts it into coordinates of a touch point and further transfers them to the processor 960 and can receive and execute a command sent by the processor 960. Moreover, the touch sensitive surface 921 can be embodied in various types of resistive, capacitive, infrared, surface sound wave and other types. The input device 920 can further include another input device 922 in addition to the touch sensitive surface 921. Particularly, the another input device 922 can include but will not be limited to one or more of a physical keyboard, functional keys (e.g., volume control press keys, an on/off press key, etc.), a track ball, a mouse, an operating arm, etc.

Although not illustrated, the input unit 920 may further include a TV broadcast receiver, a high definition multimedia interface, a USB (Universal Serial Bus) interface, etc. Furthermore, the input unit 920 may further include a remote controller receiver for receiving a signal sent from the remote controller, etc.

The output unit 930 is configured to output an audio signal, a video signal, an alarm signal, a vibration signal, etc. The output unit can include a display unit 931, an audio output module, an alarm module, etc. The display unit 931 can be configured to display information input by the user or information provided to the user and various graphic user interfaces of the TV set device 900, where these graphic user interfaces can be composed of graphics, texts, icons, videos and any combination thereof. The display unit 931 can include a display panel which can be optionally configured in the form of a Liquid Crystal Display (LCD), an Organic Light-Emitting Diode (OLED) display, a flexible display, a 3D display, etc. Furthermore, the touch sensitive surface 921 can overlie the display panel, and the touch sensitive surface 921, upon detection of the touch operation thereon or in proximity thereto, transfers it to the processor 960 to determine the type of the touch event, and thereafter the processor 960 provides a corresponding visual output on the display panel according to the type of the touch event. Although the touch sensitive surface 921 and the display unit 931 are illustrated in FIG. 9 as two separate components to perform the input and output functions, the touch sensitive surface 921 and the display unit 931 can be integrated to perform the input and output functions in some embodiments.

The TV set device 900 can further include at least one sensor 940, e.g., an optical sensor, a motion sensor and other sensors. Particularly, the optical sensor can include an ambient optical sensor and a proximity sensor, where the ambient optical sensor can adjust the brightness of the display panel according to the luminosity of ambient light rays, and the proximity sensor can power off the display panel and/or a backlight when the TV set device 900 moves to some location. A gravity acceleration sensor which is a motion sensor may detect the magnitudes of accelerations in respective directions (typically three axes) and may detect the magnitude and the direction of gravity when the sensor is stationary and may be configured to perform applications of identifying the posture of a TV set (e.g., switching between landscape and portrait modes, relevant games, calibration of the posture of a magnetometer, etc.), perform a relevant function of identifying vibration (e.g., a pedometer, a knock, etc.), etc.; and the TV set device 900 may be further configured with a gyroscope, a barometer, a hygrometer, a thermometer, an infrared sensor and other sensors, and a description of these components will be omitted here.

The audio circuit 950 may provide an audio interface between the user and the TV set device 900. The audio circuit 950 includes a speaker and a microphone. The audio circuit 950 may convert received audio data into an electric signal and transmit the electric signal to the speaker, and the speaker converts the electric signal into an audio signal for output; and on the other hand, the microphone converts a collected audio signal into an electric signal, the audio circuit 950 receives the electric signal and then converts the electric signal into audio data, and outputs the audio data to the processor 960 to be processed and then be transmitted to another terminal, for example, or the audio data is output to the memory 910 for further processing. The audio circuit 950 may further include an earphone jack for communication between a peripheral earphone and the TV set device 900.

The processor 960 is a control center of the TV set device 900, has the respective components of the entire TV set device connected by various interfaces and lines, and runs or executes the software programs and/or modules stored in the memory 910 and invokes the data stored in the memory 910 to perform the various functions of the TV set device 900 and process the data, to thereby manage and control the TV set device as a whole. Optionally, the processor 960 may include one or more processing cores; and preferably, the processor 960 may be integrated with an application processor and a modem processor, where the application processor generally handles the operating system, the user interfaces, the applications, etc., and the modem processor generally handles wireless communication. As can be appreciated, the modem processor may not be integrated into the processor 960.

The TV set device 900 further includes a power source (e.g., a battery) supplying power for the respective components, and optionally, the power source may be logically connected with the processor 960 through a power management system, to perform charging and discharging management, power consumption management, etc., through the power management system. The power source may include an external power supply source or an internal power supply source and supply power for the respective components under the control of the controller. The power source may further include one or more DC or AC power sources, recharging systems, power source failure detection circuits, power source transformers or inverters, power source status indicators and any other components.

Although not illustrated, the TV set device 900 may further include a camera, a Bluetooth module, etc., and a description thereof will be omitted here. Particularly in this embodiment, the display unit 931 of the TV set device 900 is a touch screen display, and the TV set device 900 further includes a memory in which one or more programs are stored and configured to be executed by one or more processors.

Moreover, the TV set device 900 may further include a Radio Frequency (RF) circuit. The RF circuit can be configured to receive and transmit information or a signal in the course of calling, particularly, receive downlink information from a base station and transfer the downlink information to the one or more processors 960 for processing; and also transmit uplink data to the base station. Typically, the RF circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover, the RF circuit may further communicate with a network and another device through wireless communication. The wireless communication may comply with any of communication standards or protocols including but not limited to the GSM (Global System of Mobile communication), the GPRS (General Packet Radio Service), the CDMA (Code Division Multiple Access), the WCDMA (Wideband Code Division Multiple Access), the LTE (Long Term Evolution), an e-mail, the SMS (Short Messaging Service), etc.

Moreover, the TV set device 900 may further include a WiFi (Wireless Fidelity) module 970. The WiFi falls into the category of short-range wireless transmission technologies, and the TV set device 900 can assist the user in receiving and sending an e-mail, browsing a webpage, accessing streaming media, etc., through the WiFi module, by which the user is provided with a wireless access to the broadband Internet. Although FIG. 9 illustrates the WiFi module, it can be appreciated that it may not be necessarily required for the TV set device 900 but can be omitted as desired without departing from the scope of the disclosure.

The TV set device can execute the computer program codes to perform the play control methods according to the above embodiments.

Moreover, some embodiments provide a mobile device, and FIG. 10 illustrates a schematic structural diagram of a mobile device, where the mobile device 1000 may be various handheld devices (e.g., a mobile phone, a tablet PC, a PDA, etc.) and may include a processor including one or more processing cores, a radio frequency circuit, a memory including one or more computer readable storage mediums, an input device, a display device, a sensor, an audio circuit, a WiFi module, a power source and other components. Those skilled in the art can appreciate that the structure of the mobile device 1000 in this embodiment will not be intended to be limiting but may include more or less components or have some of the components combined or a different component arrangement.

The radio frequency circuit can be configured to receive and transmit information and a signal in the course of calling, particularly, receive and transfer downlink information from a base station to the one or more processors for processing; and also transmit uplink data to the base station. Typically, the radio frequency circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover, the radio frequency circuit may further communicate with a network and another device through wireless communication. The wireless communication may comply with any of communication standards or protocols including but not limited to the GSM (Global System of Mobile communication), the GPRS (General Packet Radio Service), the CDMA (Code Division Multiple Access), the WCDMA (Wideband Code Division Multiple Access), the LTE (Long Term Evolution), an e-mail, the SMS (Short Messaging Service), etc.

The memory can be configured to store software programs and modules, and the processor is configured to run the software programs and modules stored in the memory to perform various function applications and data processing. The memory may generally include a program storage area and a data storage area, where an operating system, applications required for at least one function (e.g., an audio playing function, an image playing function, etc.), etc., can be stored in the program storage area; and data created for use of the mobile device 1000 (e.g., audio data, a phone book etc.), etc., can be stored in the data storage area. Moreover, the memory can include a high-speed random access memory and may further include a nonvolatile memory, e.g., at least one magnetic-disk memory device, a flash memory device or another volatile solid memory device. Correspondingly, the memory may further include a memory controller configured to provide an access of the processor and the input device to the memory.

The input device can be configured to receive input digital or character information and to generate a keyboard, mouse, operating arm, optical or track ball signal input related to user setting and function control. Particularly, the input device may include a touch sensitive surface and another input device. The touch sensitive surface, also referred to as a touch display screen or a touch control pad, can be configured to collect a touch operation by a user thereon or in proximity thereto (e.g., an operation by the user on or in proximity to the touch sensitive surface using his or her finger, a touchpen or any other appropriate object or attachment) and to drive a corresponding connected device according to preset program. Optionally, the touch sensitive surface may include two components which are a touch detection device and a touch controller, where the touch detection device detects the position of touching by the user and detects a signal as a result of the touch operation and transfers the signal to the touch controller; and the touch controller receives the touch signal from the touch detection device and converts it into coordinates of a touch point and further transfers them to the processor and may receive and execute a command sent by the processor. Moreover, the touch sensitive surface can be embodied in various types of resistive, capacitive, infrared, surface sound wave and other types. The input device may further include another input device in addition to the touch sensitive surface. Particularly, the another input device may include but will not be limited to one or more of a physical keyboard, functional keys (e.g., volume control press keys, an on/off press key, etc.), a track ball, a mouse, an operating arm, etc.

The display device can be configured to display information input by the user or information provided to the user and various graphic user interfaces of the mobile device 1000, where these graphic user interfaces may be composed of graphics, texts, icons, videos and any combination thereof. The display device may include a display panel which can be optionally configured in the form of a Liquid Crystal Display (LCD), an Organic Light-Emitting Diode (OLED) display, etc. Furthermore, the touch sensitive surface may overlie the display panel, and the touch sensitive surface, upon detection of the touch operation thereon or in proximity thereto, transfers it to the processor to determine the type of the touch event, and thereafter the processor provides a corresponding visual output on the display panel according to the type of the touch event. Although the touch sensitive surface and the display panel are embodied in this embodiment as two separate components to perform the input and output functions, the touch sensitive surface and the display panel may be integrated to perform the input and output functions in some embodiments.

The mobile device 1000 may further include at least one sensor, e.g., an optical sensor, a motion sensor and other sensors. Particularly, the optical sensor may include an ambient optical sensor and a proximity sensor, where the ambient optical sensor can adjust the brightness of the display panel according to the luminosity of ambient light rays, and the proximity sensor can power off the display panel and/or a backlight when the mobile device 1000 moves nearby an ear. A gravity acceleration sensor which is a motion sensor can detect the magnitudes of accelerations in respective directions (typically three axes) and can detect the magnitude and the direction of gravity when the sensor is stationary and can be configured to perform applications of identifying the posture of a mobile phone (e.g., switching between landscape and portrait modes, relevant games, calibration of the posture of a magnetometer), a relevant function of identifying vibration (e.g., a pedometer, a knock), etc.; and the mobile device 1000 may be further configured with a gyroscope, a barometer, a hygrometer, a thermometer, an infrared sensor and other sensors, and a description of these components will be omitted here.

The audio circuit may provide an audio interface between the user and the mobile device 1000. The audio circuit includes a speaker and a microphone. The audio circuit may convert received audio data into an electric signal and transmit the electric signal to the speaker, the speaker converts the electric signal into an audio signal for output; and on the other hand, the microphone converts a collected audio signal into an electric signal, the audio circuit receives the electric signal and then converts the electric signal into audio data, and outputs the audio data to the processor to be processed and then transmitted to another apparatus through the radio frequency circuit, for example, or outputs the audio data to the memory for further processing. The audio circuit may further include an earphone jack for communication between a peripheral earphone and the mobile device 1000.

The WiFi falls into the category of short-range wireless transmission technologies, and the mobile device 1000 can assist the user in receiving and sending an e-mail, browsing a webpage, accessing streaming media, etc., through the WiFi module by which the user is provided with a wireless access to the broadband Internet. Although the WiFi module is illustrated in this embodiment, it can be appreciated that it may not be necessarily required for the mobile device 1000 but may be omitted as desired without departing from the scope of the disclosure.

The processor is a control component of the mobile device 1000, has the respective components connected by various interfaces and lines, and runs or executes the software programs and/or modules stored in the memory and invokes the data stored in the memory to perform the various functions of the mobile device 1000 and process the data, to thereby manage and control the mobile phone as a whole. Optionally, the processor may include one or more processing cores; and optionally, the processor may be integrated with an application processor and a modem processor, where the application processor generally handles the operating system, the user interfaces, the applications, etc., and the modem processor generally handles wireless communication. As can be appreciated, the modem processor may not be integrated into the processor.

The mobile device 1000 further includes a power source (e.g., a battery) supplying power for the respective components, and preferably, the power source may be logically connected with the processor through a power management system, to perform charging and discharging management, power consumption management, etc., through the power management system. The power source may further include one or more DC or AC power sources, recharging systems, power source failure detection circuits, power source transformers or inverters, power source status indicators and any other components.

Although not illustrated, the mobile device 1000 may further include a camera, a Bluetooth module, etc., and a description thereof will be omitted here. In an embodiment, the display device of the mobile device 1000 is a touch screen display, and the mobile device 1000 further includes a memory in which one or more programs are stored and configured to be executed by one or more processors. The mobile device 1000 can perform the play control methods according to the above embodiments by the processor.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable data processing device provide steps for performing the functions specified in the flow(s) of the flow chart and/or the block(s) of the block diagram.

Although the embodiments in the disclosure have been described, those skilled in the art benefiting from the underlying concepts can make additional modifications and variations to these embodiments. Therefore the appended claims are intended to be construed as encompassing some preferred embodiments and all the modifications and variations coming into the scope of the disclosure.

Those skilled in the art can make various modifications and variations to the disclosure without departing from the spirit and scope of the disclosure. Thus the disclosure is also intended to encompass these modifications and variations thereto.

What is claimed is:

1. A play control method, comprising:
receiving, by a TV set device, a media play request message sent by a mobile device, wherein the media play request message carries indication information of a media program requested to be played, and the indication information of the media program indicates at least a source of the media program, and the indication information of the media program is stored by the mobile device according to the media program played by the TV set device or another TV set device or received from the TV set device or the another TV set device or another mobile device; and
playing, by the TV set device, the media program corresponding to the indication information of the media program in response to the media play request message.

2. The method according to claim 1, wherein storing, by the mobile device, the indication information of the media program according to the media program played by the TV set device or the another TV set device comprises:
sending, by the TV set device or the another TV set device, a notification message to the mobile device, wherein the notification message carries the source of the media program played by the TV set device or the another TV set device, and storing, by the mobile device, the indication information of the media program according to the notification message, wherein the indication information of the media program comprises the source of the media program played by the TV set device or the another TV set device.

3. The method according to claim 2, wherein the notification message further carries an identifier of the media program played by the TV set device or the another TV set device, and the identifier comprises one or a combination of: a channel number of a live program, a program identifier of a video on-demand program, an identifier of a file stored in an inbuilt or attached memory, an identifier of an application and an identifier of an attached player; and the indication information of the media program stored by the mobile device further comprises the identifier of the media program played by the TV set device or the another TV set device.

4. The method according to claim 3, wherein when the source of the media program played by the TV set device or the another TV set device is video on-demand, the notification message further carries play progress information, and the indication information of the media program stored by the mobile device further comprises the play progress information of the media program played by the TV set device or the another TV set device;
and wherein playing, by the TV set device, the media program corresponding to the indication information of the media program in response to the media play request message comprises:
parsing, by the TV set device, the indication information of the media program in the media play request message for the identifier and the play progress information of the media program and playing the media program corresponding to the identifier of the media program according to the play progress information.

5. The method according to claim 2, wherein sending, by the TV set device or the another TV set device, the notification message to the mobile device comprises:
sending, by the TV set device or the another TV set device, the notification message to the mobile device at a preset time interval; or
sending, by the TV set device or the another TV set device, the notification message to the mobile device upon detection of a change to a focus of a window or a change to the source of the media program played in the window where the focus is located.

6. The method according to claim 1, wherein:
when the source of the media program is a channel of a live program, the indication information of the media program comprises a first source and a first identifier, wherein the first source indicates the source of the media program, and the first identifier indicates a channel number of the live program;
when the source of the media program is video on-demand, the indication information of the media program comprises a second source and a second identifier, wherein the second source indicates the source of the media program, and the second identifier indicates a program identifier of a video on-demand program;
when the source of the media program is a file stored in an inbuilt or attached memory, the indication information of the media program comprises a third source and a third identifier, wherein the third source indicates the source of the media program, and the third identifier indicates an identifier of the file stored in the inbuilt or attached memory;
when the source of the media program is a locally installed application, the indication information of the media program comprises a fourth source and a fourth identifier, wherein the fourth source indicates the source of the media program, and the fourth identifier indicates an identifier of the application; and
when the source of the media program is an attached player, the indication information of the media program comprises a fifth source and/or a fifth identifier, wherein the fifth source indicates the source of the media program, and the fifth identifier indicates an identifier of the attached player.

7. A play control method, comprising:
receiving, by a mobile device, a notification message sent by a TV set device and storing indication information of a media program according to the notification message, wherein the notification message carries a source of the media program played by the TV set device, and the indication information of the media program comprises the source of the media program played by the TV set device; or receiving, by the mobile device, indication information of a media program from the TV set device or another mobile device, wherein the indication information indicates at least the source of the media program; and
carrying, by the mobile device, the indication information of the media program in a media play request message and sending the media play request message to the TV set device or another TV set device to instruct the TV set device or the another TV set device to play the media program corresponding to the indication information of the media program in response to the media play request message.

8. The method according to claim 7, wherein the notification message further carries an identifier of the media program played by the TV set device, and the identifier comprises one or a combination of: a channel number of a live program, a program identifier of a video on-demand program, an identifier of a file stored in an inbuilt or attached memory, an identifier of an application and an identifier of an attached player; and the indication information of the media program stored by the mobile device further comprises the identifier of the media program played by the TV set device.

9. The method according to claim 8, wherein when the source of the media program played by the TV set device is video on-demand, the notification message further carries play progress information, and the indication information of the media program stored by the mobile device further comprises the play progress information of the media program played by the TV set device, so that the TV set device or the another TV set device parses the indication information of the media program in the media play request message for the identifier and the play progress information of the media program and plays the media program corresponding to the identifier of the media program according to the play progress information.

10. The method according to claim 7, wherein:
when the source of the media program is a channel of a live program, the indication information of the media program comprises a first source and a first identifier, wherein the first source indicates the source of the media program, and the first identifier indicates a channel number of the live program;
when the source of the media program is video on-demand, the indication information of the media program comprises a second source and a second identifier, wherein the second source indicates the source of the media program, and the second identifier indicates a program identifier of a video on-demand program;
when the source of the media program is a file stored in an inbuilt or attached memory, the indication information of the media program comprises a third source and a third identifier, wherein the third source indicates the source of the media program, and the third identifier indicates an identifier of the file stored in the inbuilt or attached memory;
when the source of the media program is a locally installed application, the indication information of the media program comprises a fourth source and a fourth identifier, wherein the fourth source indicates the source of the media program, and the fourth identifier indicates an identifier of the application; and
when the source of the media program is an attached player, the indication information of the media program comprises a fifth source and/or a fifth identifier, wherein the fifth source indicates the source of the media program, and the fifth identifier indicates an identifier of the attached player.

11. A TV set device, comprising:
a memory; and
one or more processors,
wherein computer readable program codes are stored in the memory and executed by the one or more processors to implement:
receiving a media play request message sent by a mobile device, wherein the media play request message carries indication information of a media program requested to be played, and the indication information of the media program indicates at least a source of the media program, and the indication information of the media program is stored by the mobile device according to the media program played by the TV set device or another TV set device or received from the TV set device or the another TV set device or another mobile device; and
playing the media program corresponding to the indication information of the media program in response to the media play request message.

12. The TV set device according to claim 11, wherein the computer readable program codes are further executed by the one or more processors to implement:
sending a notification message to the mobile device, wherein the notification message carries the source of the media program played by the TV set device, so that the indication information of the media program stored by the mobile device according to the notification message comprises the source of the media program played by the TV set device.

13. The TV set device according to claim 12, wherein the notification message further carries an identifier of the media program played by the TV set device, so that the indication information of the media program stored by the mobile device further comprises the identifier of the media program played by the TV set device, and the identifier comprises one or a combination of: a channel number of a live program, a program identifier of a video on-demand program, an identifier of a file stored in an inbuilt or attached memory, an identifier of an application and an identifier of an attached player.

14. The TV set device according to claim 13, wherein when the source of the media program played by the TV set device is video on-demand, the notification message further carries play progress information, so that the indication information of the media program stored by the mobile device further comprises the play progress information of the media program played by the TV set device; and
the TV set device parses the indication information of the media program in the media play request message for the identifier and the play progress information of the media program and plays the media program corresponding to the identifier of the media program according to the play progress information.

15. The TV set device according to claim 12, wherein the TV set device sends the notification message to the mobile device at a preset time interval; or sends the notification message to the mobile device upon detection of a change to a focus of a window or a change to the source of the media program played in the window where the focus is located.

16. The TV set device according to claim 11, wherein:
when the source of the media program is a channel of a live program, the indication information of the media program comprises a first source and a first identifier, wherein the first source indicates the source of the media program, and the first identifier indicates a channel number of the live program;
when the source of the media program is video on-demand, the indication information of the media program comprises a second source and a second identifier, wherein the second source indicates the source of the media program, and the second identifier indicates a program identifier of a video on-demand program;
when the source of the media program is a file stored in an inbuilt or attached memory, the indication information of the media program comprises a third source and a third identifier, wherein the third source indicates the source of the media program, and the third identifier indicates an identifier of the file stored in the inbuilt or attached memory;
when the source of the media program is a locally installed application, the indication information of the media program comprises a fourth source and a fourth identifier, wherein the fourth source indicates the source of the media program, and the fourth identifier indicates an identifier of the application; and
when the source of the media program is an attached player, the indication information of the media program comprises a fifth source and/or a fifth identifier, wherein the fifth source indicates the source of the media program, and the fifth identifier indicates an identifier of the attached player.

17. A mobile device, comprising:
a memory; and
one or more processors,
wherein computer readable program codes are stored in the memory and executed by the one or more processors to implement:
receiving a notification message sent by a TV set device and storing indication information of a media program according to the notification message, wherein the notification message carries a source of the media program played by the TV set device, and the indication information of the media program comprises the source of the media program played by the TV set device; or receiving indication information of a media program from the TV set device or another mobile device, wherein the indication information indicates at least the source of the media program; and
carrying the indication information of the media program in a media play request message and sending the media play request message to the TV set device or another TV set device to instruct the TV set device or the another TV set device to play the media program corresponding to the indication information of the media program in response to the media play request message.

18. The mobile device according to claim 17, wherein the notification message further carries an identifier of the media program played by the TV set device, and the identifier comprises one or a combination of: a channel number of a live program, a program identifier of a video on-demand program, an identifier of a file stored in an inbuilt or attached memory, an identifier of an application and an identifier of an attached player; and the indication information of the media program stored by the mobile device further comprises the identifier of the media program played by the TV set device.

19. The mobile device according to claim 18, wherein when the source of the media program played by the TV set device is video on-demand, the notification message further carries play progress information, and the indication information of the media program stored by the mobile device further comprises the play progress information of the media program played by the TV set device, so that the TV set device or the another TV set device parses the indication information of the media program in the media play request message for the identifier and the play progress information of the media program and plays the media program corresponding to the identifier of the media program according to the play progress information.

20. The mobile device according to claim 17, wherein:
when the source of the media program is a channel of a live program, the indication information of the media program comprises a first source and a first identifier, wherein the first source indicates the source of the media program, and the first identifier indicates a channel number of the live program;
when the source of the media program is video on-demand, the indication information of the media program comprises a second source and a second identifier, wherein the second source indicates the source of the media program, and the second identifier indicates a program identifier of a video on-demand program;
when the source of the media program is a file stored in an inbuilt or attached memory, the indication information of the media program comprises a third source and a third identifier, wherein the third source indicates the source of the media program, and the third identifier indicates an identifier of the file stored in the inbuilt or attached memory;
when the source of the media program is a locally installed application, the indication information of the media program comprises a fourth source and a fourth identifier, wherein the fourth source indicates the source of the media program, and the fourth identifier indicates an identifier of the application; and
when the source of the media program is an attached player, the indication information of the media program comprises a fifth source and/or a fifth identifier, wherein the fifth source indicates the source of the media program, and the fifth identifier indicates an identifier of the attached player.
